(19) United States
(12) Patent Application Publication
(10) Pub. No.: US 2013/0298999 A1
(43) Pub. Date: Nov. 14, 2013

(54) METHOD AND SYSTEM FOR GASFLOW MANAGEMENT

(71) Applicant: Chih Pin Hsu, Taipei (TW)

(72) Inventor: Chih Pin Hsu, Taipei (TW)

(73) Assignee: M-FIELD ENERGY LTD., Taipei (TW)

(21) Appl. No.: 13/468,252

(22) Filed: May 10, 2012

(51) Int. Cl. F16K 21/04

(52) U.S. Cl. 137/2; 137/505

(57) ABSTRACT

A system and method for gasflow management to ensure that the output pressure is within a safety range. Upon entering the input terminal, the input source may pass through a switch valve to reach a pressure-reducing valve so that the pressure is reduced to a reduced pressure level. Then, the reduced pressure level is checked by the release valve and is lowered if the reduced pressure level is higher than the cutoff pressure associated with the release valve. The reduced pressure level is also sensed by a pressure sensor so that the controller can shut off the operation if the pressure reading is not within a safety range.

### BACKGROUND

Aspects of the present invention relate generally to the field of fuel cell, and more specifically to the gas flow control mechanism used by the fuel cell system.

A typical fuel cell system has an anode, the electrolyte, and a cathode, whereas the electrolyte is sandwiched between the anode and cathode. When a catalyst oxidizes the fuel at the anode, the fuel is transformed into a positively charged ion and a negatively charged electron. Then, the negatively charged electron causes electric current by passing through a load circuitry, while the positively charged ion passes through the electrolyte to reach the cathode. At the cathode, the positively charged ion can unite with the negatively charged electron and react with another chemical. Usually, the fuel is hydrogen and the chemical at the cathode is oxygen.

To ensure that the fuel cell operates efficiently, the flow of hydrogen must be maintained. In addition, if the hydrogen pressure is outside of the safety range, the system may become unstable and may raise safety concerns.

Accordingly, there is a need in the art for an gasflow management system that provides a safety module to ensure that the gasflow pressure inside remains within a pre-specified range.

### SUMMARY OF THE INVENTION

An gasflow management system comprises an input terminal to receive an input source with an input pressure level, a pressure-reducing valve to reduce the input pressure level to a reduced pressure level, a connector to connect the pressure-reducing valve to a release valve, a pressure sensor, and an output terminal, whereas the release valve is adapted to release a part of the input source if a first condition is met, and the pressure sensor is adapted to sense an output pressure level. In addition, the gasflow management system may further comprise a switch valve with a first state and a second state, wherein the input source may reach the pressure-reducing valve when the switch valve operates at the first state and the input source may not reach the pressure-reducing valve when the switch valve operates at the second state.

### BRIEF DESCRIPTION OF THE DRAWINGS

The foregoing and other aspects of various embodiments of the present invention will be apparent through examination of the following detailed description thereof in conjunction with the accompanying drawing figures in which similar reference numbers are used to indicate functionally similar elements.

FIG. 1 is a simplified diagram illustrating components of an gasflow management system according to an embodiment of the present invention.

FIG. 2 is a simplified block diagram illustrating components of an gasflow management system according to an embodiment of the present invention.

FIGS. 3(a) and (b) are a simplified diagrams illustrating components of an air management system according to an embodiment of the present invention.

### DETAILED DESCRIPTION

Embodiments of the present invention provide an gasflow management system that provides a safety module to ensure that the gasflow pressure remains within a pre-specified range inside the fuel cell system.

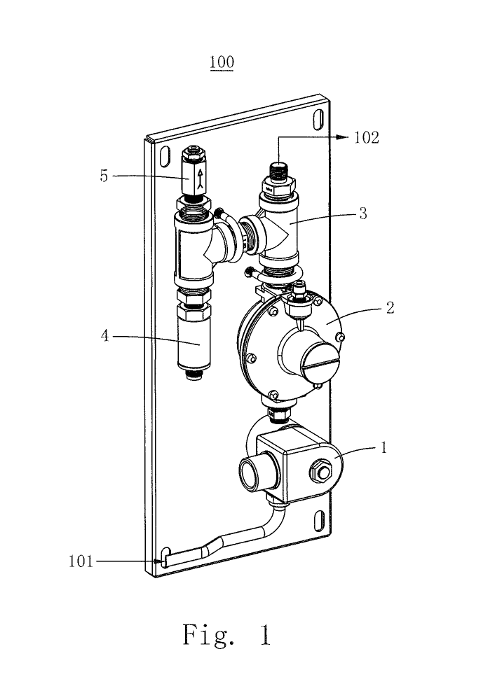

FIG. 1 is a simplified diagram illustrating components of an exemplary gasflow management system. As shown, the gasflow management system 100 may receive an input source from the input terminal 101. The input source may be the fuel used in a fuel cell system. For example, the input source may be hydrogen or oxygen. Once the input source enters the gasflow management system 100, it may pass the switch valve 1. In one embodiment of the present invention, the pressure of the input source at the input terminal 101 (“the system input pressure”) is higher than the required operating pressure, which may be the pressure at the output terminal 102 (“the system output pressure”). Having the system input pressure higher than the system output pressure may facilitate the storage of the input source. For example, the input source may be compressed and stored in a cylinder, which typically requires a higher pressure than required by the operation.

The switch valve 1 may have at least an “on” status and an “off” status such that when it is set at the “on” status, it will allow the input source to pass through, and when it is set at the “off” status, the input source will be blocked from further passage. The switch valve 1 may be an electromechanical valve. In a preferred embodiment, the switch valve 1 is a solenoid valve, which may be controlled by an electric current through a solenoid.

Once the input source passes through the switch valve, it may reach a pressure-reducing valve 2. Through its settings, the pressure-reducing valve 2 may reducing the system input pressure to the reduced pressure. As discussed, the system input pressure often needs to be reduced to a certain range to avoid damages to the operation, or accidents involving burst pipes/conduits from the abnormal pressure. Hence, the reduced pressure from the pressure-reducing valve 2 may be the preferred operating pressure. A person of ordinary skill in the art would notice that the order of the switch valve 1 and pressure-reducing valve 2 is exchangeable.

Even though the pressure-reducing valve 2 may serve to reduce the input pressure, because the risk caused by the burst pipes or damages resulted from operating with abnormal pressure are too high, the gasflow management system may benefit from additional safety mechanisms. Thus, the reduced pressure from the pressure-reducing valve 2 is passed to the pressure sensor 4 and relief valve 5 through the connector 3. The connector 3 may be a four-way connector, with terminals corresponding to the output of the pressure-reducing valve 2, the pressure sensor 4, the relief valve 5, and the output terminal 102. In one embodiment of the present invention, the connector 3 is formed by attaching two three-way connectors together, whereas the first three-way connector has terminals corresponding to the output of the pressure-reducing valve 2, the output terminal 102, and a terminal of the second three-way connector, and the second three-way connector has terminals corresponding to the pressure sensor 4, the relief valve 5, and a terminal of the first three-way connector. A person of ordinary skill in the art would appreciate that there are many ways to pass pressure from one position to another position.

Once the pressure reaches the release valve 5, the release valve 5 may release the air if the pressure it senses is over the cutoff pressure. Once the air is released, the pressure may be reduced to prevent the abnormal pressure from damaging the operation. The release valve 5 may be of any type of valve (electronic, mechanical, or electromechanical) that can be use to control or limit the pressure in a system.

Once the pressure is passed to the pressure sensor 4, the pressure sensor 4 may pass the pressure reading to the controller such that the controller may decide to shut down the gasflow management system 100 or the entire system. For example, the controller may decide to shut down the entire system if the reading is higher or lower than the safety range.

In sum, according to an embodiment of the present invention, the system output pressure at the output terminal 102 may be the reduced pressure from the pressure-reducing valve 2 subject to the cutoff pressure associated with the release valve 5 and the pressure reading sensed by the pressure sensor 4.

In one embodiment of the present invention, the input source is hydrogen with pressure around 5-6 Bar, and the preferred operation pressure is around 0.3-0.4 Bar. In this case, after passing through the pressure-reducing valve 2, the pressure of the hydrogen is reduced to 0.3-0.4 Bar. The cutoff pressure for the release valve 5 may be set at 1 Bar. Thus, when the pressure-reducing valve 2 operates normally, the reduced pressure will be around 0.3-0.4 Bar, the release valve 5 will not release the hydrogen, and the system output pressure at output terminal 102 will also be around 0.3-0.4 Bar. On the other hand, when the pressure-reducing valve 2 suffers from dysfunction, the reduced pressure may be outside the preferred operation range. For example, if the reduced pressure is 1.5 Bar, then it is higher than the cutoff pressure for the release valve 5, thereby triggering the release valve 5 to release the air until the pressure is close to 1 Bar. At this time, the pressure sensor 4 may also alarm the controller of the abnormal condition and the controller may decide whether to shut down the operation. Also, if the reduced pressure is 0.1 Bar, it will not trigger the release valve 5, but the pressure reading may be passed from the pressure sensor 4 to the controller such that the controller knows that there is inadequate pressure at the output terminal 102.

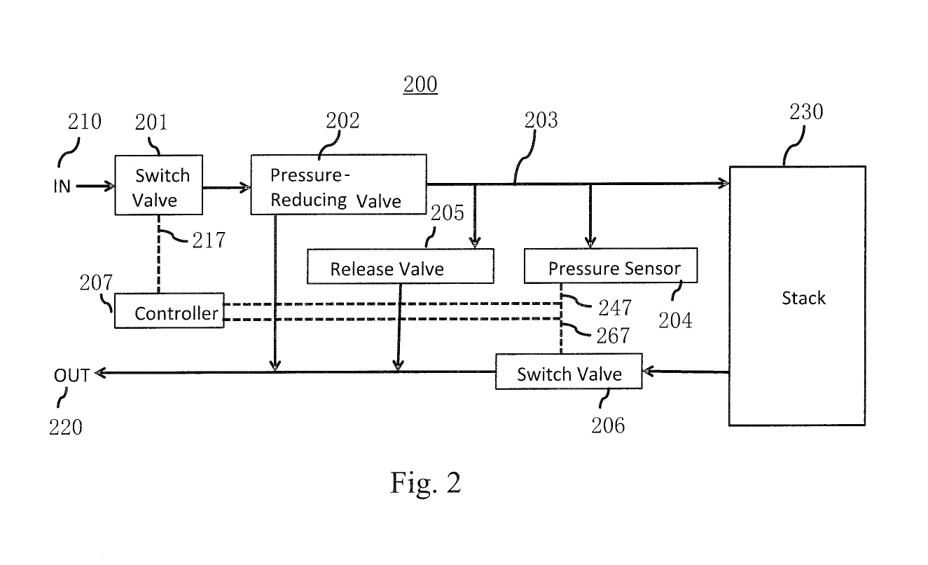

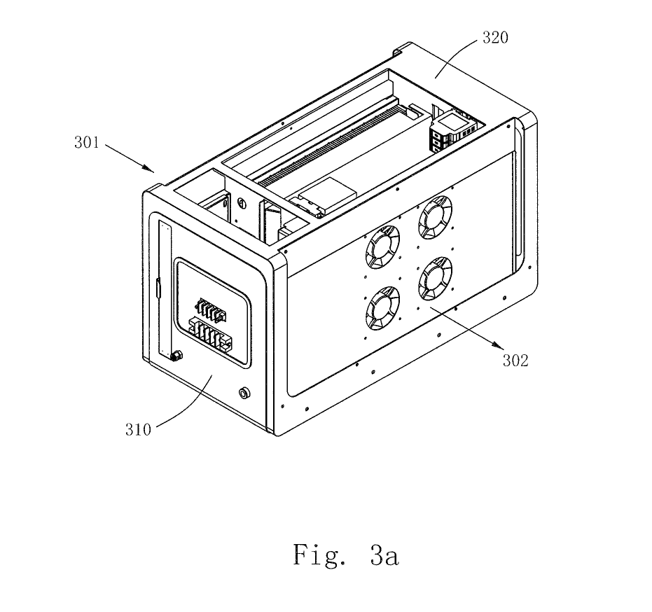

FIG. 2 is a simplified block diagram illustrating components of an exemplary gasflow management system according to an embodiment of the invention. In the figure, the solid arrows illustrate the flow of the input source, while the dotted lines illustrate the electric connections. As shown, the input source may enter at the input terminal 210. Then, the switch valve 201 may determine whether the input source may pass through the switch valve 201 based on the command from the controller 207 via electric connection 217. If the controller 207 sets the switch valve 201 to an “on” state, then the input source may then pass through the switch valve 201 and reach the pressure-reducing valve 202.

Once at the pressure-reducing valve 202, the system input pressure is reduced to the reduced pressure and the air is then passed, through the connector 203, to the release valve 205, the pressure sensor 204, and the stack 230. When the pressure-reducing valve 202 is reducing the pressure, it may release some of the air inside the pressure-reducing valve 202 to the output terminal 220.

When the air reaches the release valve 205, the release valve 205 may release the air if the pressure it detects is above the cutoff pressure. Releasing the air may keep the pressure below or close to the cutoff pressure. The released air may be ejected at the output terminal 220.

Also, the pressure sensor 204 may pass the pressure reading to the controller 207 through electric connection 247. If the controller 207 determines that the pressure is not safe for operation, the controller may shut down the operation. For example, the controller may shut down the switch valve 201, or it may cut off the power of the operation.

At stack 230, the input source may function as a fuel to the fuel cell system. For example, when the input source is hydrogen, it may enter the fuel cell system to create electric current and produce output air after reacting with oxygen at the cathode.

The output air from the stack 230 may then enter the switch valve 206. Similar to the switch valve 217, the switch valve 206 may be connected to the controller 207 through electric connection 267. During its “on” state, the switch valve may allow the output air to reach the output terminal 220. During its “off” state, the output air may not pass through the switch valve 206.

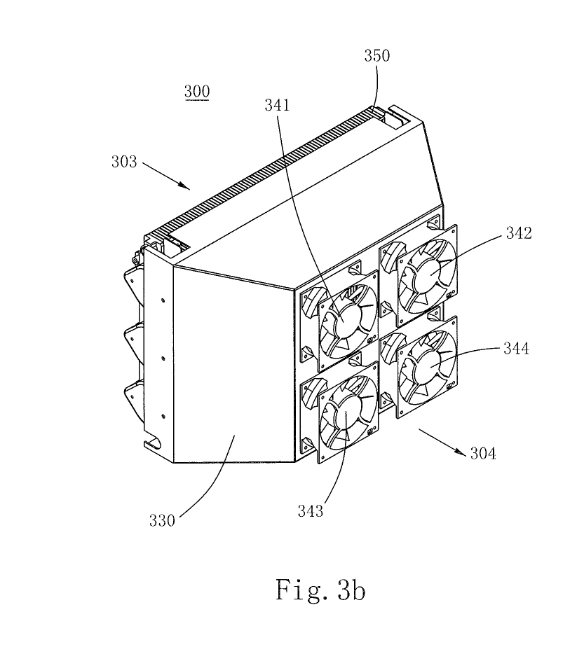

The foregoing discussion identifies types of gasflow management systems that may be used to manage the hydrogen in a fuel cell system. Another gasflow management system may be adopted for the gasflow of oxygen. FIGS. 3(a) and (b) are simplified diagrams illustrating components of an exemplary air management system according to an embodiment of the invention. As shown in FIG. 3(a), the input source may enter at direction 301 into the fuel cell stack module 310, and then exit at direction 302. To facilitate the flow of the input source, a wind guider 300, as shown at FIG. 3(b) may be attached to the fuel stack module 310 in FIG. 3(a). For example, the wind guider 300 may be attached to the fuel stack module 310 such that the input source that exists at direction 302 may then enter the wind guider 300 at direction 303. As shown in FIG. 3b, the wind guider 300 may comprise a filter 350, a wind cover 330, and fans 341, 342, 343 and 344. The filter 350 may be used to remove solid particulates such as dust and pollen from the air. The wind cover 330 may be used to facilitate the gasflow of the input source. For example, the wind cover 330 may connect the filter 350 and the fans 341, 342, 343 and 344. In addition, the cross section of the wind cover 330 at the end approximate to the filter 350 may be larger than the cross section of the wind cover 330 at the end approximate to the fans 341, 342, 343, and 344. In according with embodiments of the present invention, the winder guider 300 may have no filter, or have multiple filters. Finally, the fans 341, 342, 343 and 344 may be used to suck air from the direction 303 to direction 304. The air sucked by the fans 341, 342, 343 and 344 may be spread by the wind cover 330 such that the input source may pass through the input stack module 310 to react with the fuel cell stack.

The foregoing discussion identifies functional blocks that may be used in the fuel cell systems constructed according to the various embodiments of the present invention. In practice, these gasflow management systems may be applied to a variety of devices. While the invention has been described in detail above with references to some embodiments, variations within the scope and spirit of the invention will be apparent to those of ordinary skill in the art. Thus, the invention should be considered as limited only by the scope of the appended claims.

What is claimed is:

1. An gasflow management system, comprising:
an input terminal to receive an input source with an input pressure level;
a pressure-reducing valve to reduce the input pressure level to a reduced pressure level;
a connector to connect the pressure-reducing valve to a release valve, a pressure sensor, and an output terminal;
the release valve to release a part of the input source if a first condition is met; and
the pressure sensor to sense an output pressure level.

2. The gasflow management system of claim 1, wherein the reduced pressure level is set within a safety range adapted to a fuel cell operation.

3. The gasflow management system of claim 1, further comprising:
a switch valve with a first state and a second state, wherein the input source may reach the pressure-reducing valve when the switch valve operates at the first state and the input source may not reach the pressure-reducing valve when the switch valve operates at the second state.

4. The gasflow management system of claim 3, wherein the switch valve is connected to a controller adapted to deciding whether the switch valve should operate at the first state or the second state.

5. The gasflow management system of claim 4, wherein the pressure sensor provides a sensed pressure reading to the controller.

6. The gasflow management system of claim 5, wherein the controller determines whether the sensed pressure reading is within a safety range.

7. The gasflow management system of claim 6, wherein the controller sets the switch valve to the second state if the sensed pressure reading is not within the safety range.

8. The gasflow management system of claim 1, wherein the first condition is met when the reduced pressure level is above a predetermined cutoff pressure level.

9. The gasflow management system of claim 8, wherein the predetermined cutoff pressure level is higher then the reduced pressure level but lower than the input pressure level.

10. The gasflow management system of claim 1, further comprising a fuel cell stack connected to the output terminal such that a catalyst oxidizes the input source at an anode associated with the fuel cell stack.

11. A method of managing gasflow, comprising:
receiving an input source with an input pressure level at an input terminal;
reducing the input pressure level to a reduced pressure level at a pressure-reducing valve;
connecting the pressure-reducing valve to a release valve, a pressure sensor, and an output terminal through a connector;
releasing a part of the input source if a first condition is met at the release valve; and
sensing an output pressure level at the pressure sensor.

12. The method of managing gasflow of claim 11, wherein the reduced pressure level is set within a safety range adapted to a fuel cell operation.

13. The method of managing gasflow of claim 11, further comprising:
setting a switch valve at a first state or a second state, wherein the input source may reach the pressure-reducing valve when the switch valve operates at the first state and the input source may not reach the pressure-reducing valve when the switch valve operates at the second state.

14. The method of managing gasflow of claim 13, wherein the switch valve is connected to a controller adapted to deciding whether the switch valve should operate at the first state or the second state.

15. The method of managing gasflow of claim 14, wherein the pressure sensor provides a sensed pressure reading to the controller.

16. The method of managing gasflow of claim 15, wherein the controller determines whether the sensed pressure reading is within a safety range.

17. The method of managing gasflow of claim 16, wherein the controller sets the switch valve to the second state if the sensed pressure reading is not within the safety range.

18. The method of managing gasflow of claim 17, wherein the first condition is met when the reduced pressure level is above a predetermined cutoff pressure level, and the predetermined cutoff pressure level is higher then the reduced pressure level but lower than the input pressure level.

19. The method of managing gasflow of claim 11, further comprising connecting a fuel cell stack to the output terminal such that a catalyst oxidizes the input source at an anode associated with the fuel cell stack.

20. A system of gasflow management of a fuel cell stack module for a first input source and a second input source, comprising:
a first gasflow management system of the first input source connected to a first end of the fuel cell stack module, comprising:
an input terminal to receive the first input source with an input pressure level;
a pressure-reducing valve to reduce the input pressure level to a reduced pressure level;
a connector to connect the pressure-reducing valve to a release valve, a pressure sensor, and an output terminal;
the release valve to release a part of the input source if a first condition is met; and
the pressure sensor to sense an output pressure level; and
a second gasflow management system of the second input source connected to a second end of the fuel cell stack module, comprising:
at least one fan to provide air suction power for the second input source; and
a wind cover adapted to convey the air suction power to the second end of the fuel stack module.
